(19) United States
(12) Patent Application Publication
(10) Pub. No.: US 2007/0063521 A1
(43) Pub. Date: Mar. 22, 2007

(54) Method and apparatus for plating automotive bumpers

(76) Inventors: Christopher Lee Lancashire, Peterborough (CA); Donald Leal Elliott, Omemee (CA)

Correspondence Address: BERESKIN AND PARR, 40 KING STREET WEST, BOX 401, TORONTO, ON, M5H 3Y2, CA

(21) Appl. No.: 11/429,440

(22) Filed: May 8, 2006

Related U.S. Application Data
(63) Continuation of application No. 11/291,933, filed on Dec. 2, 2005.
(60) Provisional application No. 60/632,755, filed on Dec. 3, 2004.

(51) Int. Cl. B60R 19/02

(52) U.S. Cl. 293/102

(57) ABSTRACT

A method of plating an article such as an automotive bumper includes providing a bath of electroplating solution, the bath having at least two spaced apart anodes; immersing at least one pair of articles in the bath between the anodes, the articles having respective first surfaces directed towards the anodes and back surfaces opposite the first surfaces and directed towards each other; and simultaneously depositing metal from the electroplating solution onto the front surfaces and the back surfaces of the article to provide front and back layers of metal deposit over substantially all of the front and back surfaces, respectively. The present invention also provides a plated automotive bumper made by the method.

This application is a continuation of prior U.S. application Ser. No. 11/291,993, filed Dec. 2, 2005, which claims the benefit of Provisional Application No. 60/632,755, filed Dec. 3, 2004, each of which are hereby incorporated by reference.

### FIELD

This present specification pertains to plated articles, processes for producing plated articles, and apparatuses for plating articles. In some examples, the articles comprise automotive bumpers.

### BACKGROUND

In a particular plating process, a base article having a target surface and a back surface opposite the target surface is immersed in a plating solution, and an anode is provided adjacent the target surface. An electric field between the anode and the cathodically coupled base article causes metallic ions in the solution to plate out into a layer covering the target surface. The plating solution is agitated by releasing air bubbles in the solution, beneath the articles to be plated.

The particular plating process described above can be used to provide a metallic plating on the front surface of an automotive bumper. The front surface is defined as the surface generally exposed to view when the bumper is installed on a vehicle. In a particular application, two or more bumpers are immersed in the plating solution for simultaneous plating of the respective front surfaces of the bumpers. The front surfaces of the bumpers are directed towards anodes, and respective back surfaces (opposite the front surfaces) are shielded from the anodes by the front surface of the respective bumper or by adjacent bumpers.

### SUMMARY

The present specification discloses, among other things, one or more novel methods and apparatuses for electroplating articles. The present specification also discloses one or more novel articles plated in accordance with one or more of the methods described herein, and/or through the use of one or more apparatuses described herein.

In relation to one aspect of the present teaching, the inventors have cleverly conceived of the idea of providing a plating process in which a layer of metal is deposited on the backside of an article simultaneously while a layer of metal is deposited on the front side of the article. In the particular plating process described above, a satisfactorily controllable process for plating the front surface of an article (such as the front surface of a bumper), may be provided, but no controllable process is disclosed for plating the back surface of an article simultaneously with one or more plating steps for the front surface.

Regarding plating a bumper, providing corrosion protection on the back surface of bumpers has more recently become desirable, for reasons that may include, for example, the fact that the front end of modern vehicles often include ground effects or other trim elements below the bumper. Corrosion on the back surface of the bumper can cause unsightly dripping or staining onto such trim elements. To provide corrosion protection on the back surfaces of the bumpers plated with the particular process described above, the back surfaces are coated with an anti-corrosive substance that is sprayed or otherwise applied to the back surface after electroplating of the front surface has been completed. This procedure incurs significant additional cost due to, among other things, the additional handling and

Plating the back surface as well as the front surface may appear to incur some increased costs due to increased consumption of the metal being deposited on the article. However, the inventors have cleverly conceived of one or more processes in which it is possible to achieve improved uniformity of the thickness of metal deposit across different areas of the front surface of an article being plated, and across the different front surfaces of a plurality of articles being simultaneously plated. The increased uniformity in thickness of the front surfaces can reduce the need to overplate thicker areas in order to reach minimum thickness requirements in thinner areas, which can reduce the total amount of metal being deposited on the articles. Plating more than one article simultaneously is desirable for improved throughput in a high-volume manufacturing setting. In some examples, the methods and apparatuses disclosed herein can be used to plate 8-12 or more articles simultaneously.

For some of the methods and apparatuses disclosed herein, the inventors have had to overcome specific difficulties presented by various factors, including for example, irregularly shaped back surfaces. For example, some articles, such as, for example, some automotive bumpers, have back surfaces that can include recessed areas. A recessed area is generally defined as an area that is positioned proximate a transition (or intersection) between obliquely adjoining surfaces. Such recesses present a partially shielded or cup-shaped area that can trap stale solution, and can trap gas that can be generated as a result of the plating process or that is introduced for agitation. In some aspects of the teaching disclosed herein, circulation currents are provided in the solution to flow along and flush the recessed areas, removing gas and providing fresh solution to the back surfaces adjacent the recessed areas.

In some examples, the present specification discloses an apparatus for electroplating articles having a primary or front surface to be plated and a back surface to be plated, the back surface being generally opposite the front surface. The apparatus includes an electroplating bath containing a plating solution and adapted to receive articles to be plated. The apparatus further includes an anode immersed in the plating solution, the anode and articles positioned so that the primary surfaces of the articles are directed towards the anode. The apparatus has a device providing an electrical potential coupled to the anode to positively charge the anode and coupled to the article to negatively charge the articles. The apparatus has a circulation pump having an intake for drawing solution from the bath and an outlet for delivering solution to the bath, and at least one nozzle in fluid communication with the outlet of the pump. One or more nozzles can be provided, the nozzles being aimed to form directed circulation currents in the bath that are adapted to flow against and along the back surfaces of the article to be plated. The directed circulation currents can flow along surfaces of the articles sequentially, such as along the back surface of a first article and then along the back surface of a second article. The directed circulation currents can be defined as surface-washing currents in that they can wash along the surfaces to be plated, flushing away gas from the surfaces and providing fresh plating solution adjacent thereto.

The articles to be plated can be stacked in a number of configurations to fit multiple articles in a single bath for simultaneous processing. The articles can be arranged in a rectangular array having two columns and a plurality of rows of articles, with the rows of articles being at different elevations in the tank. The apparatus can include a header in fluid communication with the outlet of the pump and to supply the nozzles. The header can be an elongate tube that extends between the columns of articles, and adjacent the lowermost row of articles. The nozzles can include at least a first pair of nozzles, each nozzle in the first pair of nozzles being positioned near opposing ends of the header and being directed at a respective article in each row of articles, and being directed in substantially opposite directions when viewed from above. The apparatus can further include at least a second pair of nozzles, each nozzle in the second pair of nozzles being positioned adjacent the nozzles of the first pair and being directed at a respective one of the articles in a row above the lowermost row of articles. The nozzles can be eductors with intakes positioned slightly upstream of nozzle outlets. The intakes can draw in fluid through a venturi suction effect. Drawing fluid in can further assist in generating the directed flow currents.

The present specification also discloses a method of plating elongate articles is provided in which the articles have a primary surface to be plated and a back surface opposite the primary surface. The method includes immersing the articles in a plating bath in a rectangular array of two columns and a plurality of rows. The articles in each row are arranged back-to-back, with the respective primary surfaces facing outward. A header with at least two pairs of nozzles is provided in the bath, and can be positioned between the columns of articles, adjacent the lowermost row of articles. The solution in the plating bath is circulated to flow in a curving surface-washing flow path to which at least portions of the back surfaces of the articles are generally tangential.

The present specification also describes an automotive bumper having a front surface that is generally visible when the bumper is installed on a vehicle, the front surface having a finish comprising at least a first and second front layer of plated metal deposit; and a back surface opposite the front surface and including recessed areas, the back surface having a finish comprising at least one back layer of plated metal deposit covering substantially all of the back surface. The first front layer and the at least one back layer can include metal deposited simultaneously in a bath of electroplating solution. The bath can include a semi-bright nickel electroplating solution of a duplex nickel plating process.

The present specification also describes an automotive bumper that has front and back surfaces electroplated in a load in a high-volume production system. Each bumper in the load has a plating thickness that falls within a relatively narrow tolerance range along the front surface of the bumper. Each bumper in the load also has a thin, but very pure, plating on the back surface as well, even on shielded recesses or blind corner areas. The inventors have determined that a relatively thin, high-purity nickel plating provides corrosion protection, to at least the same degree as known coatings used to protect the back surface, and a thicker plating is not required.

The present specification also describes an automotive bumper made according to portions or all of one or more methods for plating an article as disclosed in the present specification.

The present specification also describes an article including a front surface and a back surface, the front surface having at least a first front layer plated in an electroplating process, the first front layer generally covering all of the front surface and including an intended metal deposit and impurities. In some examples, the purity of the first front layer is greater than about 98% intended metal, and the purity of the first front layer can be greater than at least about 99.2% intended metal through a portion of at least about 4 microns of depth. The electroplating step can include immersing the article in a bath of electroplating solution with the front surface directed towards an anode, the bath having surface-washing circulation currents for circulating fresh metal-ion rich solution generally tangentially along at least the front surface of the article. The bath of electroplating solution can include a wetting agent in sufficient concentration to provide the electroplating solution with a surface tension below about 35 dynes/cm² to facilitate removal of gas bubbles from the front surface of the article. The bath of electroplating solution can include a leveling agent in a concentration of below about 0.045 g/L.

The article can include a back surface generally opposite the front surface, the back surface having a first back layer covering generally all of the back surface and plated thereon during immersion of the article in the bath of electroplating solution. The first back layer can include an intended metal deposit and impurities, and the purity of the first back layer can be greater than about 97.5% intended metal.

The purity of the first back layer can be greater than about 98.3% intended metal through a portion of at least about 1 micron of depth. At least a portion of the surface-washing circulation currents can be directed to flow generally tangentially along the back surface, and the back surface along which the portion of the surface-washing circulation currents are directed can include recessed areas.

The electroplating solution can include nickel ions and the intended metal can include nickel. The first front layer can have a thickness of about 30-40 microns, and the first back layer can have a thickness of about 1 to 4 microns. The front and back surfaces can include an automotive bumper.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective front view of a bumper to be plated in accordance with the teaching of the present specification;

FIG. 2 is a perspective rear view of a portion of the bumper of FIG. 1;

FIG. 3 is a top schematic view of an example of an apparatus for plating the bumper of FIG. 1;

FIG. 4 is a front view of the apparatus of FIG. 3 taken along the line 4-4;

FIG. 5 is a side view of the apparatus of FIG. 3 taken along the line 5-5;

FIG. 6 is a perspective view of an example of a nozzle device of the apparatus of FIG. 3;

FIG. 7 is a photograph of a plated bumper in accordance with the present specification;

FIGS. 8 and 9 are photographs of a prototype apparatus in accordance with the present specification used to plate the bumper of FIG. 7;

FIGS. 10 and 11 are photos of the bumper of FIG. 7 after undergoing a CASS test at 22 hrs and 44 hrs, respectively;

FIG. 12 is a cross-sectional view of the portion of the bumper of FIG. 2 taken along the lines 12-12;

FIG. 13 is a schematic elevation view of another example of an apparatus for plating articles;

FIG. 14 is a perspective view showing a portion of the apparatus of FIG. 13 in greater detail; and

FIG. 15 is a perspective view of another example of an article plated in accordance with the present teaching.

### DESCRIPTION

The following description includes examples of various methods, systems, apparatuses, or processes to illustrate aspects of the teaching disclosed herein. The examples described herein are illustrative and are not intended to limit the scope of any invention that is defined by one or more claims. The examples and embodiments described herein can be modified without departing from the scope of one or more inventions as defined by one or more claims. A single claimed invention can include features from one or more examples or embodiments, and the claimed inventions are not limited to examples or embodiments having all of the features of any one example or embodiment described herein, or having features common to multiple or all of the examples or embodiments described herein. The teaching herein may include particular subject matter that is beyond the scope of the claims appended hereto. The applicants, owners, or inventors retain all rights to such particular subject matter (including, for example, the right to file divisional or continuation applications related thereto) and do not merely by the absence of inclusion in claims appended hereto abandon, disclaim, or dedicate to the public any rights to such particular subject matter.

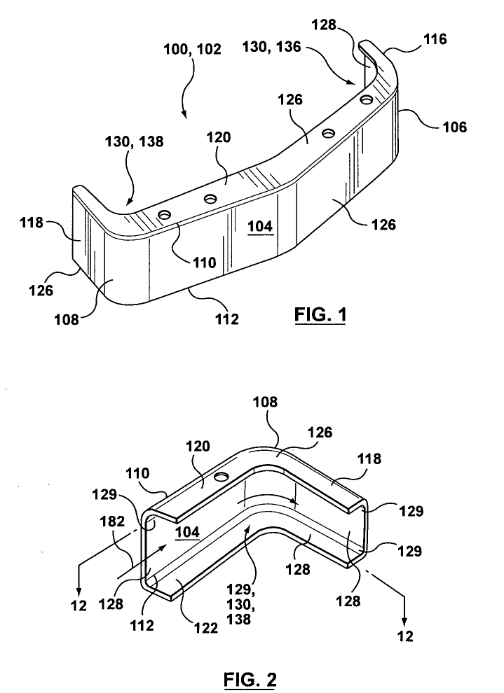

An article 100 to be plated in accordance with the present specification will first be described. As best seen in FIG. 1, the article 100 is, in the example illustrated, an automotive bumper 102. The bumper 102 has a generally elongate central body portion 104 that extends between first and second ends (also referred to as left and right ends) 106 and 108, respectively. The central body portion 104 also has upper and lower edges 110 and 112, respectively.

The bumper 102, in the illustrated example, is further provided with left and right wing portions 116 and 118, respectively, each of which extend from respective left and right ends 106 and 108 of the body portion 104. The wing portions 116 and 118 in the illustrated example are in the form of lateral extensions of the body portion 104, oriented generally orthogonally to the body portion 104 and opposed to each other. The bumper 102 can have an inwardly directed upper flange 120 extending from the upper edge 110 of the body portion 104, and an inwardly directed lower flange 122 extending from the lower edge 112. The flanges 120 and 122 extend along the length of the body portion 104, and can extend into the wing portions 116 and 118.

The bumper 102 has a front surface 126 that is generally defined by portions of the body portion 104, wing portions 116 and 118, and upper and lower flanges 120 and 122, that would or may be visible when the bumper 102 is in an installed position for use on a vehicle. The faces opposite those of the front surface 126 define a back surface 128 of the bumper 102. The portions of the back surface 128 proximate the transition between the body portion 104 and the upper flange 120, and the body portion 104 and the lower flange 122 define recessed areas 129.

The portion of the back surface 128 proximate the transition between the body portion 104 and a respective wing portion 116, 118 defines additional recessed areas 129 in the form of blind corners 130. The blind corner 130 is, in the example illustrated, substantially shielded by the body portion 104, respective wing portions 116, 118, and the upper and lower flanges 120 and 122. In the example illustrated, the bumper 102 has two blind corners 130, namely, a left blind corner 136 proximate the left wing portion 106, and a right blind corner 138 proximate the right wing portion 108.

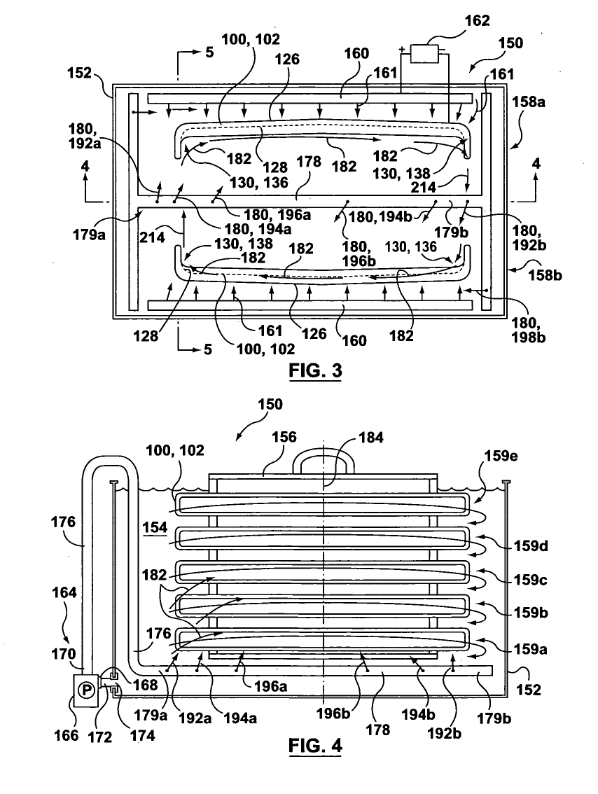

Referring now to FIGS. 3, 4, and 5, an apparatus 150 for electroplating articles such as the elongate parts 100 can be seen. The apparatus 150 has a bath or tank 152 containing an electroplating solution 154.

In the example illustrated, the apparatus 150 is adapted to electroplate nickel onto a plurality of bumpers 102. The solution 154 can include an aqueous solution of one or more nickel salts, acids, and additives. The nickel salts are generally in the form of ions in the solution 154 that can be plated out as elemental nickel on the surfaces 126, 128. The nickel can more generally be referred to as a “primary” or “intended” metal deposit, and the nickel ions as “desired” or “intended” metal ions to distinguish from tramp metals and ions which can be present (as impurities) in the plating provided on the surfaces 126, 128.

The tank 152 can be sized to accommodate a plurality of bumpers 102 to facilitate high volume production of electroplated bumpers. In the example illustrated, the bumpers 102 are supported by a rack 156, such that the bumpers 102 are arranged in a rectangular array of five bumpers 102 high and two bumpers 102 across. This provides two columns 158a and 158b and five rows 159a, 159b, 159c, 159d, and 159e of bumpers 102.

The apparatus 150 is further provided with anodes 160 along the sidewalls of the tank 152. The anodes 160 are coupled to a power supply 162. In use, the anodes 160 are positively charged, and the immersed bumpers 102 are negatively charged (i.e. coupled as cathodes). The oppositely charged anode and cathode (bumpers) provide an electric field 161 between the anodes 160 and the bumpers 102. Positively charged metal ions are supplied to the solution 154 by the anodes 160. These metal ions are drawn towards the negatively charged bumper 102, and bound to the primary surface 126.

Since the electrical field is strongest at the anode-facing primary surface 126 of the bumper 102, the primary surface 126 is where most of the plating takes place. The weaker electrical field at the back surface 126, as well as the difficulty in circulating a supply of fresh, metal ion rich solution 154 to the back surface 128 (particularly in recessed areas 129 and the blind corners 130 of the bumper 102) inhibit plating of the back surface 128. Collection and/or entrapment of air provided by known air agitation systems can further inhibit plating of the back surface 128 in the recessed areas 129.

To facilitate plating the back surface 128 in accordance with the present disclosure, the apparatus 150 is further provided with a recirculation system 164. The recirculation system 164 can provide an air-free means of agitation for the solution 154. The recirculation system 164 includes a pump 166 having an intake 168 for drawing solution from the bath, and an outlet 170 for delivering solution to the bath.

In the example illustrated, the pump intake 168 is connected by an intake line 172 to a siphon aperture 174 positioned near the bottom of a side wall of the tank 152. The pump outlet 170 is connected by a supply line 176 to a header 178. In the example illustrated, the header 178 extends lengthwise between a first header end 179a and a second header end 179b along a central lower portion of the tank 152. The header 178 can be positioned so that the vertical columns 158a, 158b of articles to be plated are on either side of the header 178 when the load has been immersed in the bath.

The recirculation system 164 of the apparatus 150 further comprises a plurality of nozzles 180 (shown schematically at arrows 180) in fluid communication with the outlet 170 of the pump 166. In the example illustrated, the nozzles 180 extend from the header 178. The nozzles 180 are directed in cooperation with each other to form directed or surface-washing circulation currents 182 in the bath. The currents 182 include currents 182a that are adapted to flow in a generally continuous and parallel path along the back surface 128 of the bumpers 102, from one end 108, 108 to the opposite end 106, 108. The surface washing currents 182 can then flow to successive ones of the articles 102. In the example illustrated, the surface washing currents 182 flow a curving and partially spiral pattern extending about a generally vertical axis 184, and are adapted to flow along a path such that the back surface 128 of the bumpers 102 is generally tangential to the curving surface-washing currents 182.

The inventors believe that the surface-washing currents 182 are better able to circulate fresh solution (with fresh supply of desired metal ions) adjacent the back surfaces 128 of the bumpers 102, particularly in recessed areas 129 and blind corners 130 of the bumper 102, when compared to known agitation techniques. This can increase the field density, and can help to maintain a sufficiently high voltage to preferentially plate out the desired (nickel) metal ions, rather than tramp metals such as copper or iron, along the back surfaces 128. Further, by flowing along the back surface 128, the currents 182 can scrub away any gas bubbles that may be adhered to the back surface 128. These gas bubbles can cause imperfections such as pitting in the plating.

The inventors have discovered that directing nozzles 180 to create a flow current that directly impinges on a surface to be plated can produce undesirable plating results, such as, for example, plating thickness and purity patterns based on distance from flow impingement. Such undesirable results can be avoided by directing the currents 182 to flow along, rather than at, the surfaces to be plated. To facilitate generating the surface-washing currents 182, the nozzles 180 can be oriented to direct flow at a generally oblique angle with respect to the back surface 128 of the bumper 102.

In the example illustrated, the recirculation system 164 includes a first pair 192 of nozzles 180, the nozzles 180 in the pair 192 being identified as nozzle 192a and nozzle 192b. The first nozzle 192a is attached to the header 178 near the first end 178a. The nozzle 192a is directly laterally outward towards where the first column 158a of articles 100 is adapted to be positioned in the bath, and is directed longitudinally towards the second end 178b of the header 178. In terms of elevation, the nozzle 192a is directed upwards towards the article in the lowermost row 159a of the stacked articles 100.

The second nozzle 192b is, in the illustrated example, generally disposed symmetrically to the first nozzle 192a, with respect to both the longitudinal and transverse centerlines of the tank 152. The nozzle 192b is, more particularly, attached to the header 178 near the second end 178b. The nozzle 192b is directed laterally outward towards where the second column 158b of articles 100 is adapted to be positioned in the bath, and is directed longitudinally towards the first end 178a of the header 178. In terms of elevation, the nozzle 192b is directed upwards towards the lowest row 159a of the stacked articles 100. The nozzles 192a and 192b of the first pair 192 are thus spaced apart from each other and oriented in generally opposite directions when projected on a plane (i.e. when viewed from above, and projected on a horizontal plane in the example illustrated). This configuration can facilitate generating the surface-washing currents 182.

The nozzles 192a and 192b of the pair 192 are thus each directed at an oblique angle towards the back surface of an article in a respective one of the columns of articles 100. The nozzles 192a and 192b are spaced-apart and are aimed in generally opposite directions. Accordingly, flow from the nozzles 192a and 192b facilitates the generation of the surface-washing current 182.

The apparatus 150 can be provided with additional nozzles 180. Additional nozzles 180 can be provided in pairs, with the nozzles 180 in a pair of nozzles being disposed in symmetrically opposite locations in the tank 152 and directed in generally opposite directions. The nozzle pairs can be directed at different elevations in the bath. Such a configuration can further enhance generation of the surface-washing flow current 182.

In the example illustrated, the apparatus 150 is further provided with an additional nozzle pair 194 having nozzles 194a and 194b. The nozzles 194a and 194b are attached in flow communication to the header 178, and positioned so that the nozzle 194a is adjacent the nozzle 192a and the nozzle 194b is adjacent the nozzle 192b. The nozzle 194a is directed laterally towards the first column 158a of articles 100, and upwards towards a row 159b of articles 100 above the lowest row 159a of articles 100 in the first 158a column. The nozzle 194b is directed laterally towards the second column 158b of articles 100, and upwards towards an article above the lowest article. Providing at least a second pair of nozzles in which the nozzles are directed at a second elevation different from the first elevation can generate an upward movement of the surface-washing flow currents 182. The upward movement can assist the flow current 182 in washing along articles 100 that are stacked above the lowest and second-lowest levels.

The illustrated example of the apparatus 150 is further provided with an additional nozzle pair 196 having nozzles 196a and 196b. The nozzles 196a and 196b are oriented similarly as those of the first and second pairs 192 and 194, but are directed at a third elevation, different from the elevation at which the first and second nozzle pairs 192, 194 are directed. The third nozzle pair 196 can further facilitate washing of the back surfaces of the articles 100 in the topmost row 159e and second topmost row 159d of articles 100 in the columns 158a and 158b of articles 100 by further strengthening an upward movement of the surface-washing current 182.

Further, the apparatus 150 can be provided with supplemental nozzles 198, 180 to further facilitate generation of the surface-washing flow current 182. The supplemental nozzles 198, 180 need not be directed at articles 100 to be plated, but can be positioned in what might otherwise be a low-flow stagnant or dead zone in the bath. In the example illustrated, the apparatus 150 is provided with a pair 198 of supplemental nozzles 198a and 198b, located at opposite corners in the tank 152. The nozzle 198a is supplied by a header spur 200a extending generally to the header 178 from the first end 178a. The nozzle 198a is directed generally towards the second end 178b of the header 178, between an adjacent tank sidewall and the first column 158a of articles 100, and at an upward elevation.

The second supplemental nozzle 198b is in fluid communication with the header 178 via a header spur 200b extending from the second end 178b. The second supplemental nozzle 198b is directed towards the first end 178a of the header 178, between an adjacent tank sidewall and the second column 158 of articles, and at an upward elevation.

Accordingly, various aspects of the present specification provide a controllable, high-volume production process for plating the back surfaces of articles, such as, for example, but not limited to, automotive bumpers. Aspects of the teaching provided herein provide a controllable process for simultaneously plating the back surface 128 and primary surface 126 of bumpers 102.

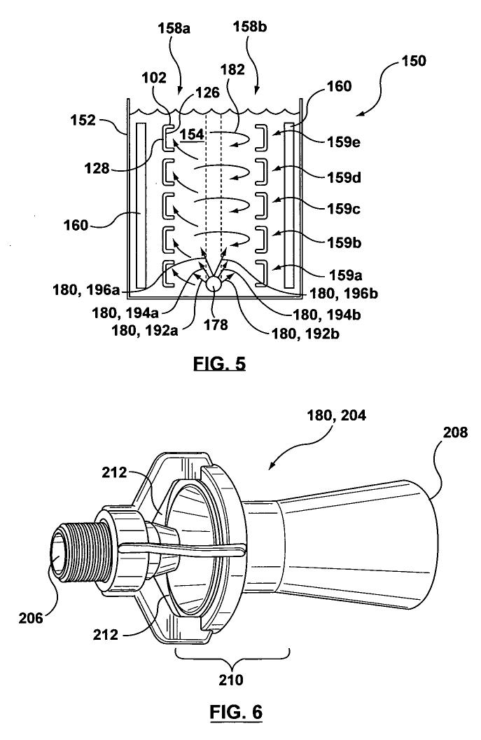

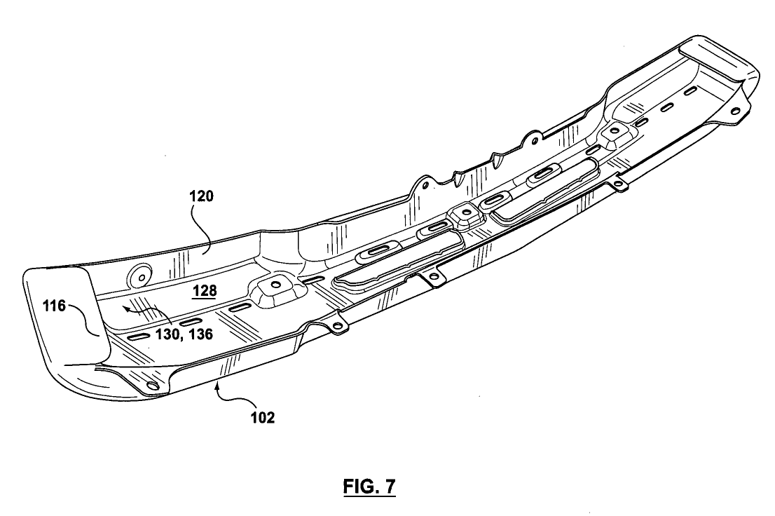

Referring to FIG. 6, the nozzles 180 of the apparatus 150 can advantageously be in the form of eductors 204. In the example illustrated, the eductors 204 have a pressure inlet 206 for connection to the header 178, and an outlet 208 opposite the inlet 206. The eductors 204 have a venturi throat section 210 between the pressure inlet 206 and the outlet 208, with induction openings 212 in the venturi throat section 210. In operation, flow of solution from the pressure inlet 206 to the outlet 208 causes a suction in the venturi throat section 210, generating a suction current 214, that draws in solution 154 from an area around the induction openings 212. The suction current 214 at the induction openings 212 of one eductor 204 in a pair of eductors can cooperate with the flow from the outlet 208 of the opposite eductor 204 in the pair of eductors to further enhance the generation of the surface-washing flow current 182.

The apparatus 150 can, in addition or as an alternative to plating the back surface 128, facilitate plating of the front surface 126. In the illustrated example, some of the currents 182 are directed to flow along the front surface 126. The currents 182 can thus remove gas bubbles from the front surface 126 as well as the back surface 128. Such gas bubbles are generally a by-product of the plating process, which involves a chemical reaction between the cathode (bumper 102) and the solution 154. During the chemical reaction, gas (hydrogen) is released in the form of small bubbles that can adhere to the surfaces 126, 128. The current 182 can scrub the bubbles off the surfaces 126, 128. Bubbles that remain on the surfaces 126, 128 can cause imperfections in the plating, such as pitting in the plated surface. In the example illustrated, the flow rate from the nozzles 180 is sufficiently high to create currents 182 that are strong enough to scrub or wash the bubbles off of the surfaces 126, 128.

On the other hand, providing too strong a current 182 can also create plating imperfections. For example, a high flow rate through eductors 204 can, as the inventors have learned, create a pressure drop across the eductors sufficient to cause a phase change of certain components in the solution 154, from liquid to gas. Such gas takes the form of bubbles that can become entrained in the current 182, and that can become deposited on the surfaces 126, 128 of the bumper 102 to be plated. The inventors have discovered that the flow rate of solution 154 through the eductors 204 should be kept low enough to avoid such vapourization in the solution 154. This can mean that the recirculation system 164 of the apparatus 150 is preferably operated near the lower end of the flow rate specified for satisfactory operation of the eductors 204. In some examples of the present specification, eductors 204 having a specified operating flow range of 13.5-30.0 gallons per minute were used. The recirculation system 164 in some examples was operated so that the flow rate across the eductors 204 was preferably from about 14 to 18 gpm, and most preferably from about 15 to 16 gpm.

To facilitate plating the front surface 126 and back surface 128 of the bumpers 102 by the apparatus 150, the composition of the plating solution 154 can be modified relative to plating solutions used in conventional plating operations. The plating solution 154 can be tailored to account for the presence of the circulation currents 182 in the tank 152, and for the absence of typical agitation means such as air agitation.

For example, the plating solution 154 can be provided with a concentration of wetting agent in a higher range than used in conventional plating systems. The wetting agent reduces the surface tension of the solution 154, which can facilitate removing gas bubbles from the front and back surfaces 126, 128 during plating. In some known plating systems, wetting agent is added in sufficient concentration to provide a surface tension of the solution 154 of about 35-45 dynes/cm². Reducing the surface tension further is generally not possible in known systems, because increased concentrations of wetting agent can cause process problems such as foaming, particularly where air agitation is used. In the apparatus 150 (having no air agitation), potential for foaming of the solution 154 is substantially reduced, thus enabling operating the process with higher levels of wetting agent to provide lower surface tension values.

In some examples of the apparatus 150, the solution 154 has been operated with surface tension of below 35 dynes/cm². A satisfactory surface tension range in some examples is 30-35 dynes/cm². Operating the apparatus 150 at such reduced solution surface tension values can improve removal of gas bubbles from surfaces being plated, and can significantly reduce the occurrence of quality problems associated with pitting on the plated surfaces 126 and 128.

Additionally or alternatively, the solution 154 can be modified to have a lower concentration of leveling agent, as compared to known plating systems. A leveling agent, generally in the form of an organic additive, can be added to plating solutions to increase brilliancy of the plated deposit and to preferentially plate valleys (e.g. scratches) in the surface to be plated, so that a smooth, flat surface is provided. In some known plating systems, the solutions include a concentration of leveling agents in the range of about 0.6 to 0.8 oz/100 gal (or about 0.045 to 0.06 g/L). Below these levels, the plating deposit (using known plating systems) typically exhibits unsatisfactory brilliance and/or has unacceptable peaks and valleys (surface imperfections).

In the apparatus 150 of the present specification, the inventors have discovered that very satisfactory plating can be accomplished using a concentration of leveling agent in the solution 154 of below about 0.6 oz/100 gal, or below about 0.045 g/L. In some examples, the leveling agent includes a coumarin-based leveling agent in a concentration of about 0.03 to 0.04 g/L of solution 154.

The plating on the surfaces 126, 128 using the apparatus 150 and the solution 154 with a leveling agent concentration in this range was remarkably brilliant and presented excellent surface finish. The reduction in the amount of leveling agent presents a significant cost saving in view of the high price of the additive, and provides benefits in a reduction of potentially harmful emissions.

To plate articles 100 in accordance with the present specification, the articles 100, such as bumpers 102, can be stacked in two columns 158a, 158b, in a bath of plating solution. The bumpers 102 in each column 158 can have back surfaces 128 directed towards the back surfaces 128 of articles 100 in the opposing column 158, and can have primary surfaces 126 opposite the back surfaces 128. The bumpers 102 can be oriented generally horizontally (i.e. longitudinal axis aligned generally horizontally). Anodes 160 can be provided adjacent the primary surfaces 126, and the bumpers 102 can be cathodically charged. A generally surface-washing fluid current 182 can be generated in the bath and between the opposing back surfaces 128 of bumpers 102 in the first and second columns 158a, 158b. The back surfaces 126 can be generally tangential to curved portions of the surface-washing flow current 182.

The present teaching provides plated articles 100 produced in a high-volume, mass-production processing system. The articles 100 can be bumpers 102 having a primary surface 126 plating thickness with a relatively high degree of uniformity. The bumpers 102 have a back surface 128 opposite the primary surface that is provided with a thinner but very pure plating that is sufficiently corrosion resistant to satisfy many standards, which can include, for example, ASTM BA56-95 (standard Specification for Electrodeposited Coatings of Copper Plus Nickel Plus Chromium and Nickel Plus Chromium), 22 hr CASS test (ASTM B368-97, Standard Test Method for Copper-Accelerated Acetic Acid Salt Spray Testing), or a 168 hr salt fog test (ASTM B117, Standard Practice for Operating Salt Spray (Fog Apparatus)).

Some methods and apparatuses of the present specification can be used in baths other than, or in combination with, the bath of semi-bright nickel plating solution 154 described hereinbefore. For example, bumpers 102 can be immersed in a bright-nickel plating solution, either as an alternative to, or in combination with, the semi-bright plating step of a duplex nickel plating process. A layer of nickel can be plated simultaneously on the front and back surfaces 126 and 128 of the bumper 102 when immersed in the bright-nickel plating solution. Accordingly, a bumper 102 can be provided having a front surface 126 with a first front layer of semi-bright nickel, and a second front layer of bright nickel deposit, and a back surface 128 having a first back layer of bright nickel deposit, or a first back layer of semi-bright nickel deposit in combination with a second back layer of bright nickel deposit.

It is to be understood that the terms “first” and “second” as used herein with respect to layers of metal deposit on the front and back surfaces is for distinguishing the layers for clarity of discussion, and is not intended to be limiting with respect to the order in which the layers may be applied.

Articles other than bumpers 102 can be plated in accordance with the applicant's teaching disclosed herein. For example, other automotive components such as body panels, grilles, or fenders can be plated with one or more combinations of features of more than one of the apparatuses described herein. The resultant article can have a metal deposit layer of relatively uniform thickness, high purity, and excellent surface finish. The process can consume less metal and/or additives, less power, and can produce fewer emissions. The articles can have a plastic (or other non-conductive) substrate or base material that is coated with a conductive layer prior to electroplating.

### EXAMPLES

Aspects of the present disclosure can be further understood with reference to the following examples, which are not intended to limit the teachings of the specification in any way.

### Example 1

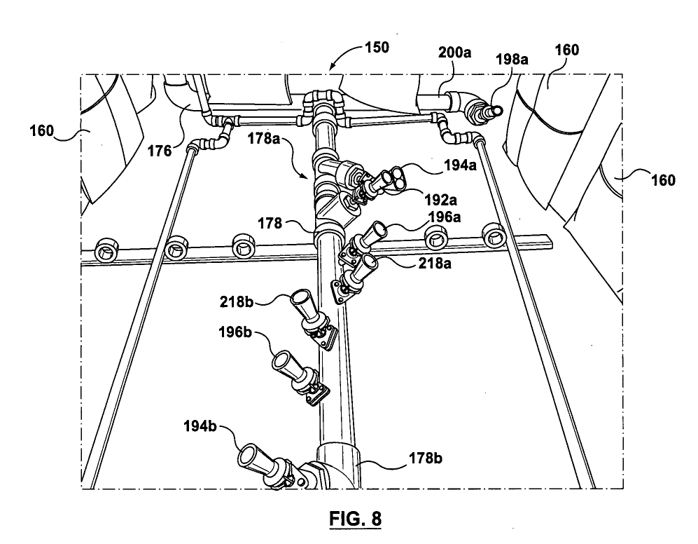

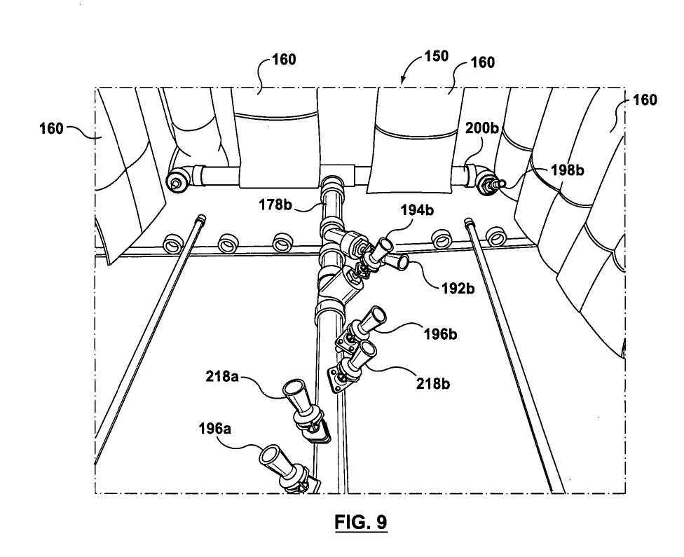

A plating apparatus 150 was prepared in accordance with the present specification. Illustrations based on photographs of the apparatus 150 can be seen in FIGS. 8 and 9. In the example apparatus 150, ten nozzles in the form of eductors 204 were provided in the tank 152. The ten nozzles included nozzle pairs 192, 194, 196, and 198, plus an additional nozzle pair 218. The additional nozzle pair 218 included first and second nozzles 218a and 218b mounted in flow communication to the header 178, between nozzles 196a and 196b. The nozzles 218a and 218b were directed at a further increased elevation, to further enhance upward motion of the curving, partially spiral flow 182 and to improve desired circulation along bumpers 102 in the uppermost rows 159d and 159e.

The bumpers 102 were stacked in a load of two columns 158 and five rows 159, as described previously. The load was immersed in the bath for about 30 minutes, with the bath operating at a current of about 2700-3100 amps and voltage of 10-12 volts.

The plated bumpers 102 produced in the example had a primary surface 126 plated to a thickness of about 50 microns to 65 microns for bumpers 102 in the top rows 159e, and a plating thickness of about 35 microns to 45 microns for bumpers 102 in the bottom row 159a.

The back surface 128 of the bumpers 102 in the example were provided with a plating thickness of about 1.0 micron to about 4.0 microns for each bumper 102 in the load, regardless of row 159.

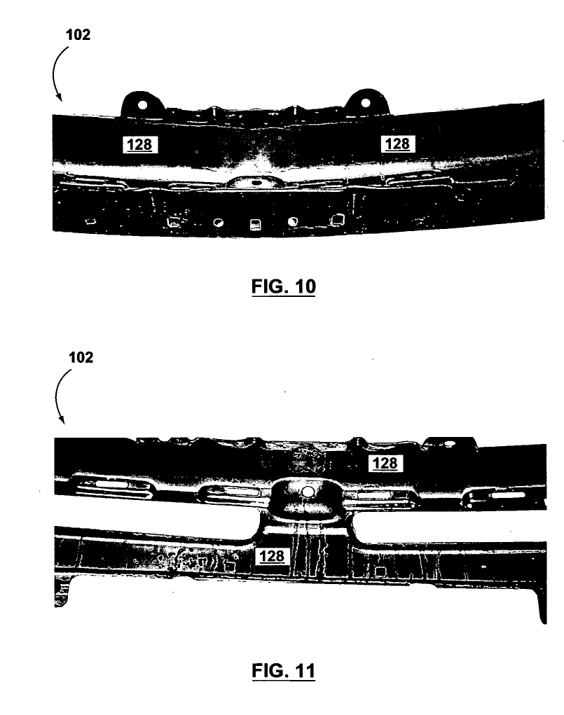

The bumpers 102 produced in the example were subjected a 22 hr and 44 hr CASS Testing, with the resultant tested bumpers seen in FIGS. 10 and 11, respectively. The bumpers passed applicable acceptance criteria set out in ASTM B456-95.

### Example 2

A plating apparatus 150 was prepared in accordance with the present specification and loaded with two columns 158 and five rows 159 of bumpers 102, as described previously.

The load was immersed in a bath of semi-bright nickel plating solution including nickel sulphate and nickel chloride, operated at 120 to 130° F. and about 3.5 to 4.5 pH. A wetting agent (NPA-90 from Atotech Canada (Division of Atotech Deutschland GmbH)) was added in sufficient quantity to maintain the surface tension of the solution between about 30 to 36 dynes/cm². A coumarin-based leveling agent (P104 from Atotech Canada) was added in concentration of about 0.030 to about 0.045 g/L of solution.

The recirculation system was operated to provide a flowrate of about 150 US gal/min to the bath. Current density was adjusted to about 30 amps/ft². The duration of plating was set at about 38 to 42 minutes, and in one specific example was set at 2365 seconds.

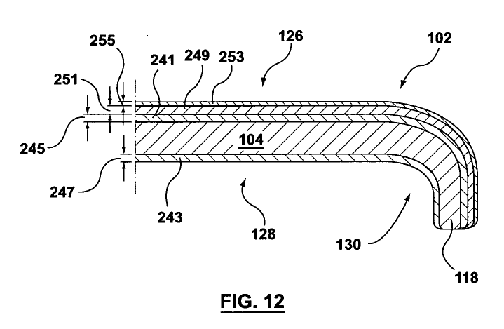

With reference to FIG. 12, the plated bumpers 102 emerging from the semi-bright bath exhibited a front surface 126 having a first front layer 241 of plated nickel deposit, and a back surface 128 having a first back layer 243 of plated nickel deposit. The first front layer 241 had an average thickness 245 in the range of 30 to 40 microns, was remarkably uniform in thickness, and exhibited very high purity (about 98-99.5% pure nickel). The purity of the layers generally refers to the concentration of the intended metal deposit in comparison to other substances, such as copper or iron.

The first back layer 243 was thinner than the first front layer 241, having an average thickness 247 of about 1-4 microns. The thickness 247 of the first back layer 243 was substantially uniform over all of the back surface 128, including the recessed areas 130. The purity of the metal deposit of the first back layer 243 was also remarkably high, having an elemental nickel content of about 97-98.5%. At some levels along the depth of the first back layer 243, the purity of the metal deposit was between about 98.7-98.9% intended metal (i.e. nickel).

The purity of the first back layer 243 in accordance with the present teaching is believed to be significantly more pure than known plating layers using known methods, particularly on surfaces facing away from anodes in an electroplating process. This relatively greater purity can contribute to the effectiveness of the layer 243 in protecting the surface 128 against corrosion. The purity of the first front layer 241 can also be generally greater than that of known layers provided on anode-facing surfaces, at least along certain portions of the depth of the layer. Thus satisfactory corrosion protection for the surfaces 126, 128 can be obtained with layers that are significantly thinner than the thickness of known corrosion protection layers, which can provide cost savings through the use of less metal for deposit from the solution 154.

Across bumpers within the load, the variation in thickness of the total metal deposit on each of the front surface 126 and back surface 128 across a given bumper 102 and across bumpers 102 in different positions on the rack 156 was remarkably low. The reduced thickness variation can result in a significant reduction in total nickel consumption, by reducing the amount of overplating of thicker plating areas otherwise necessary in order to meet minimum thickness requirements in thinner plating areas.

In some loads of the present example, the front surfaces 126 had a total metal deposit (all layers combined) with a maximum to minimum thickness variation of about 8-10 microns. This refers to the difference between the average thickness of the thickest total nickel deposit (generally about 45 microns, corresponding to bumpers 102 in the top row 159e) and the average thickness of the thinnest total nickel deposit (generally about 35 microns, corresponding to bumpers 102 in the bottom row 159a).

The variation in thickness of the first back layer 243 of different bumpers 102 in the load was also very low. For example, the difference between the thickest first back layers 243 (bumpers 102 in top row 159e) and the thinnest first back layers 243 (bumpers 102 in bottom row 159a) was generally about 3 to 4 microns or less.

Relative to known semi-bright plating systems using, for example, air agitation, the apparatus 150 consumed less power (operated at about 10 to 20% less amperage per square foot), consumed less nickel (about 12% less nickel), and consumed less leveling agent (about 25 to 30% less P104). The apparatus 150 used only slightly more wetting agent in the solution, because despite the increase in wetting agent used to decrease the operating surface tension values, the solution 154 was found to be slightly more stable at the lower surface tension levels, thus requiring less in-process wetting agent addition.

Following the semi-bright plating step, the load of bumpers 102 was processed in a bright nickel bath, where a second front layer 249 was deposited on the front surface 126, over the first front layer 241. The bright nickel bath was, in the example presently described, operated in accordance with known plating baths, having air agitation, higher current usage (about 35 Amps/ft²), and higher surface tension values of the solution. The second front layer 249 had an average thickness 251 of about 5-10 microns. During the bright nickel plating process using air agitation and without flow currents 182, a negligible amount of metal was deposited on the back surface 128.

Following the bright nickel, the load of bumpers 102 was processed in a chromium plating solution to provide a third front layer 253 having a thickness 255 of about 0.25-0.35 microns. As for the bright nickel step, the chromium plating step provided negligible metal deposit on the back surface 128 of the bumper 102.

Depth profile tests were conducted on a bumper 102 to measure the concentration of chromium, copper, iron, and nickel at various depths from the outermost surface of the bumper. The results are reported below in Table A for the front surface 126, and Table B for the back surface 128. For each table, the chromium layer is the outermost layer and is very thin. The nickel layer(s) extend beneath the chromium layer. At greater depths (below the nickel layers), the iron content rises dramatically, indicating entry into the base metal of the bumper.

The plated layers 241, 243, 249 are seen to have high purity (i.e. high nickel percent) and low levels of impurities (such as copper and iron). The first front layer 241 has a purity (nickel %) that is generally in the range of about 99.2-99.3%. The second front layer 249 has a purity that is generally in the range of about 99.05-99.08%. The first back layer 243 has a purity that is generally in the range of about 98.1-98.9%.

TABLE A
Depth Profile of Front Surface

| | Chromium | | | |
|---|---|---|---|---|
| Depth (Microns) | (%) | Copper (%) | Iron (%) | Nickel (%) |
| 0.00 | 65.43 | 0.20 | 0.12 | 0.99 |
| 1.50 | 0.09 | 0.03 | 0.01 | 98.56 |
| 3.00 | 0.02 | 0.03 | 0.00 | 99.05 |
| 4.50 | 0.01 | 0.03 | 0.00 | 99.05 |
| 6.00 | 0.00 | 0.03 | 0.00 | 99.08 |
| 7.50 | 0.00 | 0.03 | 0.00 | 99.21 |
| 9.00 | 0.00 | 0.08 | 0.01 | 99.15 |
| 10.50 | 0.00 | 0.04 | 0.01 | 99.21 |
| 12.00 | 0.00 | 0.03 | 0.02 | 99.28 |
| 13.50 | 0.00 | 0.02 | 0.02 | 99.25 |
| 15.00 | 0.00 | 0.01 | 0.01 | 99.27 |
| 16.50 | 0.00 | 0.01 | 0.02 | 99.32 |
| 18.00 | 0.00 | 0.01 | 0.01 | 99.21 |
| 19.50 | 0.00 | 0.01 | 0.02 | 99.24 |
| 21.00 | 0.00 | 0.01 | 0.02 | 99.27 |
| 22.50 | 0.00 | 0.01 | 0.02 | 99.26 |
| 24.00 | 0.00 | 0.01 | 0.02 | 99.29 |
| 25.50 | 0.00 | 0.01 | 0.02 | 99.20 |
| 27.00 | 0.00 | 0.01 | 0.02 | 99.25 |
| 28.50 | 0.00 | 0.01 | 0.02 | 99.19 |
| 30.00 | 0.00 | 0.01 | 0.02 | 99.25 |
| 31.50 | 0.00 | 0.01 | 0.02 | 99.26 |
| 33.00 | 0.00 | 0.01 | 0.01 | 99.21 |
| 34.50 | 0.00 | 0.01 | 0.02 | 99.23 |
| 36.00 | 0.00 | 0.01 | 0.01 | 99.20 |
| 37.50 | 0.00 | 0.01 | 0.01 | 99.11 |
| 39.00 | 0.00 | 0.07 | 0.60 | 98.51 |
| 40.50 | 0.01 | 0.12 | 26.07 | 72.60 |
| 42.00 | 0.01 | 0.07 | 47.63 | 50.77 |
| 43.50 | 0.01 | 0.06 | 61.70 | 36.50 |
| 45.00 | 0.01 | 0.05 | 62.46 | 35.82 |

TABLE B
Depth Profile of Back Surface

| | Chromium | | | |
|---|---|---|---|---|
| Depth (Microns) | (%) | Copper (%) | Iron (%) | Nickel (%) |
| 0.00 | 81.78 | 0.09 | 0.20 | 1.19 |
| 0.50 | 0.00 | 0.06 | 0.00 | 97.38 |
| 1.00 | 0.00 | 0.35 | 0.00 | 98.13 |
| 1.50 | 0.00 | 0.09 | 0.16 | 98.34 |
| 2.00 | 0.00 | 0.05 | 0.18 | 98.63 |
| 2.50 | 0.00 | 0.05 | 0.18 | 98.79 |
| 3.00 | 0.00 | 0.05 | 0.15 | 98.88 |
| 3.50 | 0.00 | 0.07 | 0.39 | 98.72 |
| 4.00 | 0.00 | 0.24 | 8.45 | 90.43 |
| 4.50 | 0.01 | 0.17 | 45.13 | 53.36 |
| 5.00 | 0.01 | 0.10 | 74.85 | 23.46 |
| 5.50 | 0.02 | 0.08 | 87.88 | 10.11 |
| 6.00 | 0.02 | 0.06 | 94.48 | 3.37 |
| 6.50 | 0.02 | 0.05 | 96.53 | 1.26 |
| 7.00 | 0.03 | 0.04 | 97.13 | 0.60 |
| 7.50 | 0.03 | 0.04 | 97.39 | 0.32 |
| 8.00 | 0.02 | 0.05 | 97.31 | 0.34 |

### Example 3

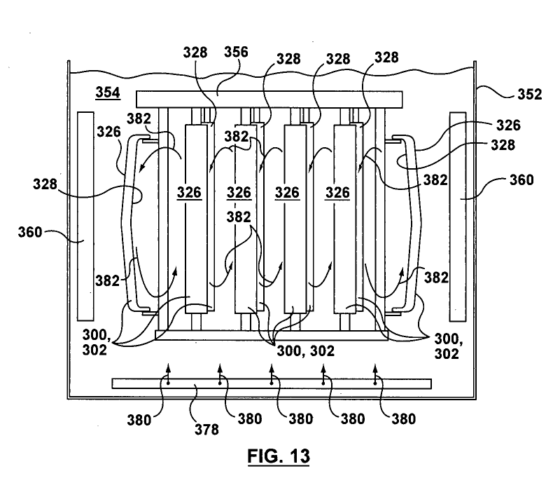

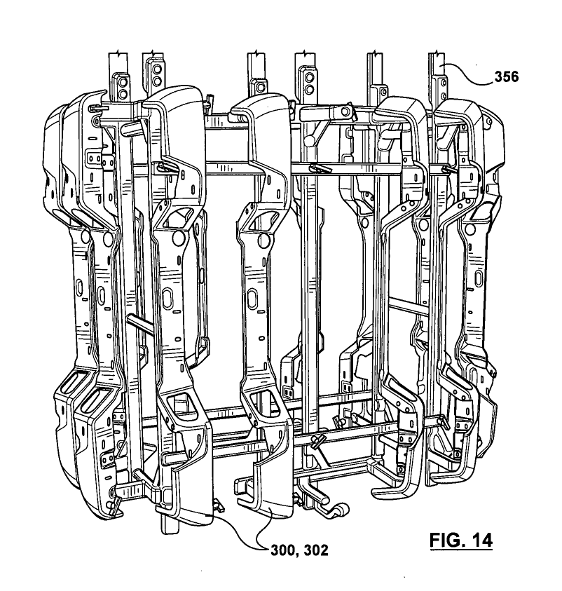

Referring to FIGS. 13 and 14, a modified plating apparatus 350 was provided, being similar to the plating apparatus 150 and having like features denoted by like reference characters, incremented by 200. In the example illustrated, the apparatus 350 was used to plate a bumper 302 similar to bumper 102 and having like features denoted by like reference characters, incremented by 200. The apparatus 350 included a tank 352 with plating solution 354, for holding a plurality of bumpers 302 supported by a rack 356. In the apparatus 350, the rack 356 was configured to support the bumpers 302 in a generally vertical orientation, with opposed ends 306, 308 of the body portion 304 being generally in vertical alignment About 12 or 14 bumpers 302 were supported on the rack 356, generally around the periphery thereof, with back surfaces 328 facing inwardly towards each other, and front surfaces 326 directed outwards.

The apparatus 350 was provided with nozzles 380 to generate surface-washing flow currents 382 in the solution 354. In the example illustrated, the flow currents 382 were generally curving/circular, flowing about a generally horizontal axis and along the relatively tangential back surfaces 328.

The bumpers 302 plated with the apparatus 350 exhibited similar plating deposits as the bumpers 102 plated with the apparatus 150. Advantageously, the bumpers 302 showed even less bumper-to-bumper variation in plating thickness, and the apparatus 350 was able to hold more bumpers per load as compared to the apparatus 150.

### Example 4

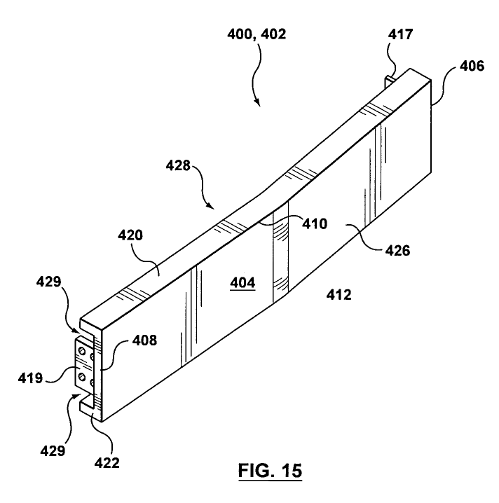

Another example of an article 400 plated in accordance with the present specification can be seen in FIG. 15. The article 400 is a beam-style bumper 402 having an elongate central portion 404 with left and right ends 406, 408 and upper and lower edges 410, 412. Rather than having integral wings, the bumper 402 is provided with left and right wing brackets 417, 419 to which separate wing elements (not shown) can be fastened. The back surface 428 of the bumper 402 may not have the same blind corners 130 as the bumper 102, but generally still has some recessed areas 429 such as those provided proximate the transition between the central body portion 404 and the upper and lower flanges 420 and 422, respectively.

The bumper 402 plated in accordance with the present specification exhibited similar metal deposits on the front and back surfaces 426, 428 as the bumpers 102, 302.

It is to be understood that the teaching of the inventors described herein can be used to deposit metals other than nickel. For example, zinc or other metals can be plated on articles such as bumpers or other articles to provide functional and/or cosmetic properties to such articles.

1. A process for producing a plated article, comprising:
a) providing a bath of electroplating solution, the bath having at least two spaced apart anodes;
b) immersing at least one pair of articles in the bath between the anodes, the articles having respective front surfaces directed towards respective ones of the anodes and back surfaces opposite the front surfaces; and
c) simultaneously depositing metal from the electroplating solution onto the front surfaces and the back surfaces of the articles to provide front and back layers of metal deposit over substantially all of the front and back surfaces, respectively.

2. The process of claim 1, wherein step c) includes generating surface-washing circulation currents in the bath to flow generally tangentially along at least a portion of the back surfaces of the articles.

3. The process of claim 2, wherein step c) is free of air introduction into the solution.

4. The process of claim 3, wherein steps a) to c) comprise a semi-bright plating step in a duplex nickel plating process.

5. The process of claim 3, wherein the surface tension of the electroplating solution is adjusted to be in the range of about 30 to 36 dynes/cm².

6. The process of claim 3, wherein the electroplating solution comprises a leveling agent in a concentration below about 0.045 g/L.

7. The process of claim 2, comprising drawing solution from the bath and reintroducing the solution through at least one nozzle.

8. The process of claim 7, wherein the at least one nozzle comprises at least a first pair of nozzles, one of the nozzles of the first pair of nozzles being obliquely directed towards the back surface of a first article of the pair of articles, the other of the nozzles of the first pair of nozzles being obliquely directed towards the back surface of a second article of the pair of articles.

9. The process of claim 8 wherein the nozzles comprise eductors.

10. The process of claim 2 wherein step b) includes immersing a second and at least a third pair of articles in the bath with the first pair of articles.

11. An automotive bumper, comprising:
a) a front surface that is generally visible when the bumper is installed on a vehicle, the front surface including a first and at least a second front layer of plated metal deposit; and
b) a back surface opposite the front surface and having recessed areas, the back surface including at least a first back layer of plated metal deposit covering substantially all of the back surface;
c) and wherein the first back layer and at least one of the first and second front layers comprise an intended metal deposited simultaneously in a bath of electroplating solution.

12. The bumper of claim 11, wherein the first back layer has a thickness of at least about 1 micron over generally all of the back surface.

13. The bumper of claim 12, wherein the first back layer has an average thickness in a range of about 2-4 microns.

14. The bumper of claim 12, wherein the first back layer has a purity of at least about 97.5% intended metal.

15. The bumper of claim 12, wherein the first front layer has a thickness of at least about 30 microns.

16. The bumper of claim 15, wherein the first front layer has a maximum to minimum thickness variation of less than about 10 microns.

17. The bumper of claim 11, wherein the at least one front layer has a purity of at least about 98% intended metal.

18. The bumper of claim 11, wherein the bath comprises a semi-bright nickel electroplating solution of a duplex nickel plating process, and the intended metal comprises nickel.

19. An apparatus for electroplating articles having a front surface to be plated and a back surface to be plated, the back surface being generally opposite the front surface and having at least one recessed area, the apparatus comprising:
a) a bath containing an electroplating solution and adapted to receive articles to be plated;
b) an anode immersed in the plating solution and positioned to face the front surface of the article when immersed in the bath;
c) an electrical potential coupled to the anode to positively charge the anode and coupled to the article to negatively charge the article;
d) a circulation pump having an intake for drawing solution from the bath and an outlet for delivering solution to the bath; and
e) a plurality of nozzles in fluid communication with the outlet of the pump, the plurality of nozzles directed in cooperation with each other to form surface-washing circulation currents in the bath that are adapted to flow in a generally continuous and parallel path along the front and back surfaces of the article to be plated.

20. A plated article, comprising: a front surface and a back surface, the front surface having at least a first front layer plated in an electroplating process, the first front layer generally covering all of the front surface and including an intended metal deposit and impurities, wherein the purity of the first front layer is greater than about 98% intended metal.
